(19) United States
(12) Patent Application Publication
(10) Pub. No.: US 2015/0251138 A1
(43) Pub. Date: Sep. 10, 2015

(54) Process for Using a Cross-Flow Filter Membrane to Remove Particles from a Liquid Stream

(71) Applicant: E I DU PONT DE NEMOURS AND COMPANY, WILMINGTON, DE (US)

(72) Inventors: SIMON FRISK, NEWARK, DE (US); ROBERT CHRISTENSEN, PINOLE, CA (US)

(73) Assignee: E I DU PONT DE NEMOURS AND COMPANY, WILMINGTON, DE (US)

(21) Appl. No.: 14/200,193

(22) Filed: Mar. 7, 2014

(51) Int. Cl. B01D 61/14

(52) U.S. Cl. CPC B01D 61/14

(57) ABSTRACT

A process is provided for separating particles from a liquid stream by a crossflow mechanism. The liquid stream is passed tangentially across a membrane, where the membrane comprises an active layer that has a fibrous structure in the form of a nonwoven, and the nonwoven has i) a mean flow pore size of 0.03 to 1.7 microns, ii) a maximum pore size of 3.1 microns, and an active layer having a mean thickness of less than 300 microns.

### FIELD OF THE INVENTION

The invention relates to a process for using a cross-flow filter membrane to remove particles from a liquid stream.

### BACKGROUND OF THE INVENTION

Crossflow (or tangential flow) filtration entails passing a liquid (e.g. a suspension, a dispersion, or a solution) to be filtered tangentially across one side of a membrane. An applied pressure is typically used to force a portion of the liquid through the membrane to the filtrate or downstream side of the membrane. As in traditional “normal flow” or “dead end” filtration methods, particles too large to pass through the membrane are retained on the feed or upstream side of the membrane. However, in contrast to normal flow filtration, these particles are swept along by the tangential flow so that there is not a “build-up” of particles on the membrane. Membranes used for crossflow filtration are typically non fibrous pore-containing films composed of plastic or ceramic or else of glass or metal. These membranes typically have a thin active region of less than 20 μm where active region is understood to refer to that region of the membrane in which the actual filtration takes place. The membrane is used such that active region is typically located on the particle rich side. In the case of typical crossflow filter membranes the active region is usually only a small portion in the thickness of the membrane. The rest of the membrane serves primarily as a supporting body and has a limited influence on the filtration.

Typical membranes have limited permeability (i.e. low throughflow rate) due to their structures. To overcome this deficiency, in order to have an economical filtration process, users can either increase the total area of membrane to get an acceptable overall process flux, or increase the pressure differential of the liquid across the membrane (i.e. trans-membrane pressure or TMP) to force more liquid through. Typically both these actions are taken. Increasing the TMP will often result in shorter filtration cycles and/or membrane life by causing premature membrane fouling (i.e., particles are forced or pressed into the structure to greater degree due to the higher liquid pressure). The liquid tangential flow rate (i.e. crossflow rate) across the surface of the membrane is adjusted to attempt to control deposits on the surface of the active layer of the membrane (e.g. cake or gel layer) that can reduce the filtration performance.

The filtration processes are interrupted by cleaning cycles used to regenerate fouled membranes and extend their overall useful life. The cleaning cycle may not remove all the fouling species and may result in membrane degradation. Long membrane life is required to have an economical filtration process, for both plastic and ceramic membranes.

It is desired to overcome the disadvantages of known cross flow filtration methods and membranes.

### SUMMARY OF THE INVENTION

The present invention is directed to a process for separating particles from a liquid stream that includes the steps of:
(a) providing a liquid stream to be filtered comprising particles and providing a membrane for separating the particles having a first surface, and a second surface that is opposite to the first surface;
(b) passing the liquid stream tangentially across the first surface of the membrane;
(c) recovering a particle rich fraction of the liquid stream from the first surface of the membrane; and
(d) recovering a particle depleted fraction of the liquid stream from the second surface of the membrane;
   wherein the membrane comprises an active layer that has, or in some embodiments consists of, a fibrous structure in the form of a nonwoven, where the nonwoven has i) a mean flow pore size of 0.03 to 1.7 microns, ii) a maximum pore size of 3.1 microns or less, and iii) an active layer with a mean thickness of less than 300 microns.

The present invention also provides a crossflow filtration membrane, or filtration device having a membrane where the membrane contains an active layer that has or consists of a fibrous structure in the form of a nonwoven, where the nonwoven has i) a mean flow pore size of 0.03 to 1.7 microns, ii) a maximum pore size of 3.1 microns or less, and iii) an active layer with a mean thickness of less than 300 microns.

### BRIEF DESCRIPTION OF THE FIGURES

FIG. 1 shows a scanning electron microscopy (SEM) image of the top surface of Comparative example 1 (C1) at low (top photo) and high (bottom photo) magnifications.

FIG. 2 shows an SEM image of a cross section of Comparative example 1 (C1), at low (top photo) and high (bottom photo) magnifications.

FIG. 3 shows an SEM image of the top surface of Comparative example 7 (C7) at low (top photo) and high (bottom photo) magnifications.

FIG. 4 shows an SEM image of a cross section of Comparative example 7 (C7), at low (top photo) and high (bottom photo) magnifications.

FIG. 5 shows an SEM image of PES Sample 1, top surface, at low (top photo) and high (bottom photo) magnifications.

FIG. 6 shows an SEM image of PES Sample 1, cross-section at low (top photo) and high (bottom photo) magnifications.

FIG. 7 shows an SEM image of PES Sample 3, top surface at low (top photo) and high (bottom photo) magnifications.

FIG. 8 shows an SEM image of PES Sample 3, cross-section at low (top photo) and high (bottom photo) magnifications.

### DETAILED DESCRIPTION OF THE INVENTION

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether such ranges are separately disclosed. Where a range of numerical values is recited herein, unless otherwise stated, the range is intended to include the endpoints thereof, and all integers and fractions within the range.

The term “membrane” as used herein refers to the element of a filtration device that serves to separate particles from a liquid stream. A membrane could be, without limitation, a film, a nonwoven, a woven fabric, a net or mesh, but is generally characterized by having a two dimensional structure with opposing surfaces and a thickness between the surfaces of much smaller dimension relative to the dimensions of the surfaces.

The term “particle” as used herein is not limited in terms of type, size, shape, or composition.

The term “nonwoven” means a web including a multitude of randomly distributed fibers. The fibers generally can be bonded to each other or can be unbonded. The fibers can be staple fibers or continuous fibers. The fibers can comprise a single material or a multitude of materials, either as a combination of different fibers or as a combination of similar fibers each comprised of different materials. A “nanoweb” is a nonwoven web that comprises nanofibers. The term “nanoweb” as used herein is synonymous with the term “nanofiber web.” The fibers forming the nonwoven web can be of various fiber diameter sizes including for example, nanofibers. In one embodiment of the present invention the fibers forming the nonwoven web may have a number average fiber diameters of less than about 7000 nm, or even less than 5000 nm, or even less than 3000 nm.

The term “continuous” when applied to fibers means that the fibers have been laid down during the manufacture of a nonwoven structure in one continuous stream, as opposed to being broken or chopped.

The term “nanofiber” as used herein refers to fibers having a number average diameter or cross-section less than about 1000 nm, even less than about 800 nm, even between about 50 nm and 500 nm, and even between about 100 and 400 nm or even 150 and 600 nm. The term diameter as used herein includes the greatest cross-section of non-round shapes.

The term “nanoweb” as applied to the present invention also refers to a nonwoven web constructed predominantly of nanofibers. Predominantly means that greater than 50% of the fibers in the web are nanofibers. In the case of non-round cross-sectional nanofibers, the term “diameter” as used herein refers to the greatest cross-sectional dimension. The nanoweb of the invention can also have greater than 70%, or 90% or it can even contain 100% of nanofibers.

The as-spun nonwoven or nanoweb of the present invention can be consolidated by processes known in the art (e.g. calendering) in order to impart desired improvements in physical properties. The term “consolidated” generally means that the nonwoven or nanoweb has been through a process in which it is compressed and its overall porosity has been reduced. In one embodiment of the invention the as-spun nonwoven or nanoweb is fed into the nip between two unpatterned rolls in which one roll is an unpatterned soft roll and one roll is an unpatterned hard roll. The temperature of one or both rolls, the composition and hardness of the rolls, and the pressure applied to the nonwoven can be varied to yield the desire end use properties. In one embodiment of the invention, one roll is a hard metal, such as stainless steel, and the other a soft-metal or polymer-coated roll or a composite roll having a hardness less than Rockwell B 70. The residence time of the web in the nip between the two rolls is controlled by the line speed of the web, preferably between about 1 m/min and about 50 m/min, and the footprint between the two rolls is the machine direction (MD) distance that the web travels in contact with both rolls simultaneously. The footprint is controlled by the pressure exerted at the nip between the two rolls and is measured generally in force per linear cross-direction (CD) dimension of roll, and is preferably between about 1 mm and about 30 mm.

Further, the nonwoven web can be stretched, optionally while being heated to a temperature that is between the glass-transition temperature (T_{g}) and the lowest onset-of-melting temperature (Tₒₘ) of the fiber polymer. The stretching can take place either before and/or after the web passes through the calender roll nip, and in either or both of the MD or CD.

By “partially fused” in the context of the surface of a nonwoven, for example a nanoweb, it is meant that regions exist wherein at least a portion of the fibers on the surface have been fused such that individual fiber structure in that portion is not visible in a micrograph of the surface of the nonwoven, although fused fibers may be visible in which the outlines of fibers may be seen.

By “stand alone” or “unsupported” as applied to a nonwoven structure, it is meant that in operation, the structure does not require a backing medium or scrim over any or all of its surface, although it may be supported by its edges.

By the use of the term “crossflow filtration” it is meant the separation of particles from a fluid (e.g., liquid blood), by passing or circulating the fluid (i.e. feed) parallel or tangential to the surface of the membrane. A portion of the fluid traverses the membrane (i.e. filtrate), with the rest of the fluid at the same time continuing to flow tangentially along the upstream side of the membrane (i.e. retentate). The retentate is typically more concentrated in particles, while the filtrate is typically less concentrated in particles than the feed fluid. If desired, all or a portion of the retentate can be recirculated and passed across the surface of the membrane multiple times. Such techniques are well known in the art. However, fibrous membranes, particularly the preferred membranes described herein, have not been utilized for cross-flow filtration. The term “liquid stream” as used herein is synonymous with the terms “fluid” and “fluid stream”

The term “active layer” refers to the region of a membrane where filtration of a fluid takes place. For the filtrate passing through the active layer, the concentration of particles in the filtrate after passing through the active layer is essentially the same as that of the filtrate that exits the membrane. In a system where the filtration membrane consists only of a nonwoven, for example a nanoweb layer or fine fiber layer, the active layer should be taken as synonymous with the thickness of the nonwoven. In a system where the nonwoven (e.g. nanoweb layer or fine fiber layer) is supported on a more open substrate, scrim, or coarse fiber layer, the active layer should be taken as synonymous with the thickness of the nonwoven, as negligible removal of solid particles takes place in the open substrate, scrim, or coarse fiber layer.

In one embodiment, the invention is directed to a process for separating particles from a liquid stream comprising the steps of:
(i) providing a liquid stream comprising particles, and providing a membrane having a first surface and a second surface that is opposite to the first surface,
(ii) passing the liquid stream to be filtered tangentially across the first surface of the membrane,
(iii) recovering a particle rich fraction of the liquid stream from the first surface of the membrane, and
(iv) recovering a particle depleted fraction of the liquid stream from the second surface of the membrane,

wherein the membrane comprises an active layer that has, and/or consists of a fibrous structure in the form of a nonwoven, and where the nonwoven has
i) a mean flow pore size of 0.03 to 1.7 microns and a maximum flow pore size of less than 3.1 microns; and
ii) the mean thickness of the nonwoven is less than 300 microns.

In further embodiments, the thickness of the nonwoven may be less than 100 microns, less than 50 microns or even less than 40 microns. In some embodiments, the thickness of the active layer of the nowoven is less than 300 microns, or even less than 100 microns, less than 50 microns, or less than 40 microns.

The fibrous structure comprises fibers that may comprise polymers. In some embodiments, the polymers are selected from at least one of polyether sulfone (PES), polysulfone (PS), polyimide (PI), polyvinylidene fluoride (PVdF), polyacrylonitrile (PAN), polypropylene (PP), polyamide (PA), or cellulose or combinations thereof.

The active layer may comprise a plurality of distinct fibrous layers in a face to face relationship that are not mutually entangled.

In a further embodiment, the nonwoven is a nanoweb, and the nanoweb comprises nanofibers. The nanofibers may be continuous. The nanoweb may be attached to a support layer that is situated on the side of the nanoweb opposite of the side that contacts the liquid to be filtered. The support layer is not a part of the active layer of the membrane.

The surface of the nanoweb that is in contact with the liquid stream to be filtered may be at least partially fused.

The fibrous structure of the invention may be a nonwoven in an as-spun condition or consolidated or stretched. The nonwoven may be a nanoweb. The as-spun nanoweb comprises primarily or exclusively nanofibers, advantageously produced by electrospinning or electroblowing, and in certain circumstances, by meltblowing or other such suitable processes. Classical electrospinning is a technique illustrated for example in U.S. Pat. No. 4,127,706, which is incorporated herein in by reference in its entirety, where a high voltage is applied to a polymer in solution to create nanofibers and nonwoven mats. However, total throughput in electrospinning processes is too low to be commercially viable in forming heavier basis weight webs.

An example of an “electroblowing” process useful for making nonwovens of the present invention is disclosed in PCT Patent Publication WO 03/080905 which is incorporated by reference in its entirety. A stream of polymeric solution comprising a polymer and a solvent is fed from a storage tank to a series of spinning nozzles within a spinneret, to which a high voltage is applied and through which the polymeric solution is discharged. Meanwhile, compressed air that is optionally heated is issued from air nozzles disposed in the sides of, or at the periphery of the spinning nozzle. The air is directed generally downward as a blowing gas stream which envelopes and forwards the newly issued polymeric solution and aids in the formation of the fibrous web, which is collected on a grounded porous collection belt above a vacuum chamber. The electroblowing process permits formation of commercial sizes and quantities of nanowebs at basis weights in excess of about 1 grams per square meter (g/m²), even as high as about 40 g/m² or greater, in a relatively short time period.

Nonwovens such as nanowebs useful in the present invention can also be produced by a process of centrifugal spinning. Centrifugal spinning is a fiber forming process comprising the steps of supplying a spinning solution or melt having at least one polymer optionally dissolved in at least one solvent to a rotary sprayer having a rotating conical nozzle, the nozzle having a concave inner surface and a forward surface discharge edge; issuing the spinning solution from the rotary sprayer along the concave inner surface so as to distribute said spinning solution toward the forward surface of the discharge edge of the nozzle; and forming separate fibrous streams from the spinning solution while the solvent vaporizes to produce polymeric fibers in the presence or absence of an electrical field. A shaping fluid can flow around the nozzle to direct the spinning solution away from the rotary sprayer. The fibers can be collected onto a collector to form a fibrous web. Examples of centrifugal spinning processes are found in U.S. Pat. Nos. 8,277,711 and 8,303,874 which are hereby incorporated in their entirety by reference.

A substrate or scrim can be arranged on a collector device to collect and combine the nanofiber web. Examples of substrates/scrims include various nonwoven cloths, such as meltblown or spunbond nonwoven cloths, needle-punched or spunlaced nonwoven cloths, woven cloth, knitted cloth, paper, and the like, and can be used without limitations so long as a nanofiber layer can be added on the substrate/scrim.

The nonwoven cloth can comprise spunbond fibers, dry-laid or wet-laid fibers, cellulose fibers, meltblown fibers, glass fibers, or blends thereof.

In one embodiment of the invention, the nonwoven is a nanoweb, and in a further embodiment, at least 50% of the fibers have a fiber diameter of less than 1,000 nm.

The nonwoven may also comprise fibers with a number average fiber diameter of 0.2 to 10 microns. One example of such a nonwoven may be a melt blown nonwoven fabric. Commercial melt blowing processes, as taught, for examples by, U.S. Pat. No. 3,849,241 to Buntin, et al, use polymer flows and heated high velocity air streams developed from an air pressure source to elongate and fragment the extruded fiber. This process also reduces the fiber diameter significantly. The typical meltblown die directs air flow from two opposed nozzles situated adjacent to the orifice such that they meet at an acute angle at a fixed distance below the polymer orifice exit. Depending on the air pressure and velocity and the polymer flow rate the resultant fibers can be discontinuous or substantially continuous.

The nonwoven may therefore comprise fibers that individually have a fiber diameter in the range of 0.2 to 10 microns and preferably 0.2 to 7 microns.

The nonwoven or nanoweb may be a stand-alone structure (i.e., “unsupported”) or attached to a support layer that is situated on the side of the nonwoven or nanoweb opposite to the side that contacts the liquid stream. In such embodiments where a support layer is used, the support layer is not a part of the active layer of the membrane. Support layers have coarser pore sizes. The support layer can be for example a permeable film, a nonwoven, a woven fabric, a net or mesh.

A fibrous structure construction according to the present invention may therefore include a single or multiple nonwoven layers. In one embodiment, the nonwoven layer with the smallest pore size is preferably situated on the surface of the structure that is in contact with the fluid to be filtered and constitutes the active layer.

Whether or not a support layer is present, the mean pore size in the active layer may be from 0.03 to 5 microns, or from 0.2 to 2 microns, or even from 0.45 to 1 microns. The maximum pore size may be for example 3.1 microns or less. In one embodiment, the mean flow pore size is between 0.3 and 1.7 microns and the maximum pore size is 3.1 microns.

In one embodiment, a first support layer comprises a permeable coarse fibrous material with fibers having an average diameter of at least 10 microns, typically and preferably about 12 (or 14) to 30 microns. The first layer of permeable coarse fibrous material may, in some embodiments, comprise a media having a basis weight of no greater than about 300 g/m² and at least 15 g/m². In other embodiments, the basis weight may be from about 70 to 270 g/m². In one embodiment, a first layer of permeable coarse fibrous media is at least 0.0005 inch (12 microns) thick, and typically and preferably is about 0.001 to 0.030 inch (25-800 microns) thick.

In one embodiment, the liquid stream is tangentially fed across the membrane at a flow rate (i.e. crossflow rate) of between 0.1 and 2 m/s, or even 0.1 to 7 m/s, and in particular 0.1 to 1 m/s. In this flow rate range, a particularly efficient filter performance is possible. The energy for recirculating the liquid is reduced by the low speed compared to conventional methods.

The trans-membrane pressure (TMP) is generally between 0.1 and 2 bar and can be even 4 bar.

The flow rate of permeate through the membrane (through flow rate) can advantageously be regulated by means of filtration process variables, for example by adjusting the TMP across the membrane. The throughflow rate could be adjusted to a constant value, but a predetermined time profile can also be advantageous. The flow rate can be, for example, 100 to 200 liters/m²/h for filtration of a beverage.

The membrane of the invention can be integrated into any suitable design of filter device, for example a spiral wound element, a plate-and-frame system, a tubular device, or other configurations that rely on cross-flow principles to achieve filtration. Thus, the present invention is also directed to a filter device containing the membrane useful in the present invention as described herein.

In a further embodiment the fibrous structure comprises fibers that comprise polymers. The fibrous structure may further comprise fibers formed from at least one of polyether sulfone (PES), polysulfone (PS), polyimide (PI), polyvinylidene fluoride (PVdF), polyacrylonitrile (PAN), polypropylene (PP), polyamide (PA), or cellulose or combinations thereof.

In a still further embodiment, the fibrous structure is a stand-alone structure, in which no supporting layer is present except that the fibrous structure is supported by its edges.

The active layer of the membrane may also comprise a plurality of distinct layers in a face to face relationship and that are not mutually entangled.

In another embodiment, the first surface of the membrane is a first surface of the nonwoven that is in direct contact with the liquid stream. In such an embodiment, the membrane may further optionally comprise one or more support layers where the support layers are attached on a second surface of the nonwoven that is opposite to the first surface that is in contact with the liquid stream. In some embodiments, the nonwoven that provides a first surface of the membrane may be a nanoweb.

In one embodiment of the process, the nanoweb that is in contact with the feed liquid is at least partially consolidated. Such consolidation may be carried out for example by a process of calendaring, described herein.

### EXAMPLES

### Test Methods

Mean flow core size and maximum pore size (bubble point) were measured according to ASTM Designation E 1294-89, “Standard Test Method for Pore Size Characteristics of Membrane Filters Using Automated Liquid Porosimeter” which approximately measures pore size characteristics of membranes with a pore size diameter of 0.05 μm to 300 μm by using automated bubble point method from ASTM Designation F 316 using a capillary flow porometer (model number CFP-34RTF8A-3-6-L4, Porous Materials, Inc. (PMI), Ithaca, N.Y.). Individual samples (8, 20 or 30 mm diameter) were wetted with low surface tension fluid (1,1,2,3,3,3-hexafluoropropene, or “Galwick,” having a surface tension of 16 dyne/cm). Each sample was placed in a holder, and a differential pressure of air was applied and the fluid removed from the sample. The differential pressure at which wet flow is equal to one-half the dry flow (flow without wetting solvent) is used to calculate the mean flow pore size using supplied software. Bubble Point or maximum flow pore refers to the largest pore size.

Basis Weight (BW) was determined by ASTM D-3776, which is hereby incorporated by reference and reported in g/m² (gsm).

Thickness was determined by ASTM D-645 (or ISO 534), which is hereby incorporated by reference, under an applied load of 10 kPa and an anvil surface area of 200 mm². The thickness is reported in mils and converted to micrometers.

### Samples Tested

Micron ratings refer to the nominal size of the micro-organisms that the filter is capable of removing from a suspension. The rating of the comparative samples was supplied by the manufacturer.

Comparative samples tested were;

C1 0.2 micron polyether sulfone (PES) (Koch Membrane Systems MFK603)

C2 0.05 micron PES. (Microdyn® MP005)

C3 0.16 micron PES (Microdyn®, experimental sample)

C4 0.2 micron polysulfone (PSu) (Alfa Laval, GRM0.2PP)

C5 0.1 micron PSu. (Alfa Laval, GRM0.1PP)

C6 300 kDa MWCO PES (Hydronautics, Supro300.)

C7 1.4 micron PES (Koch Membrane Systems, MFK601)

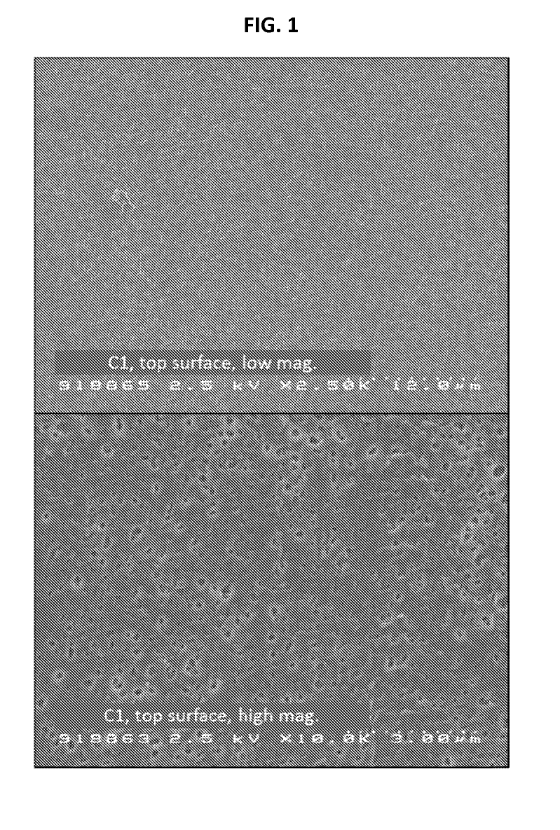

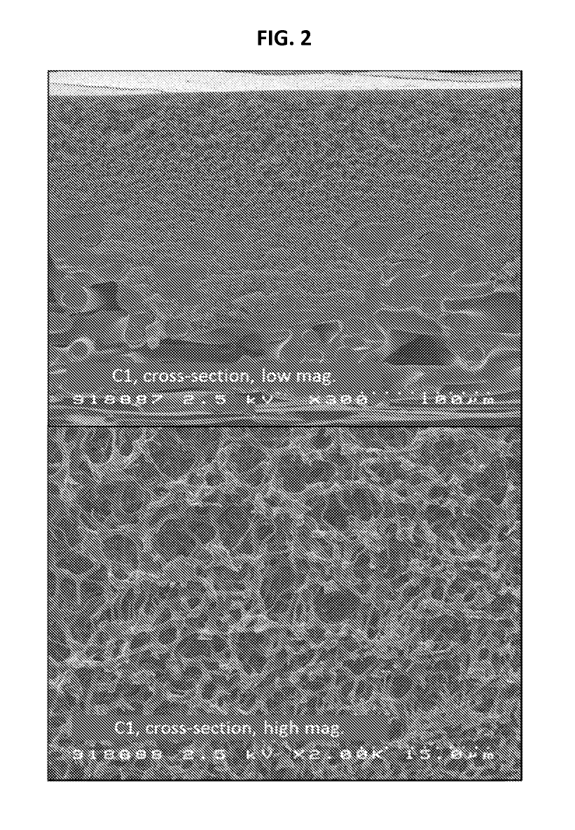

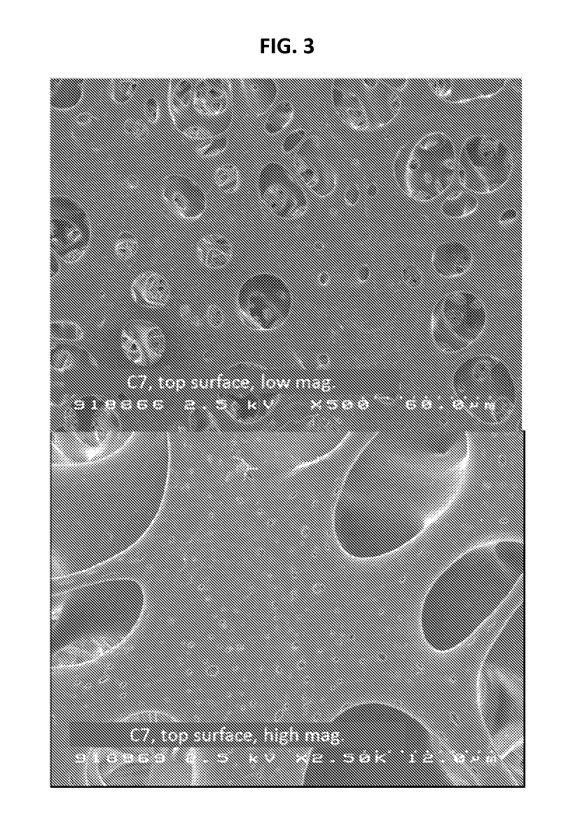

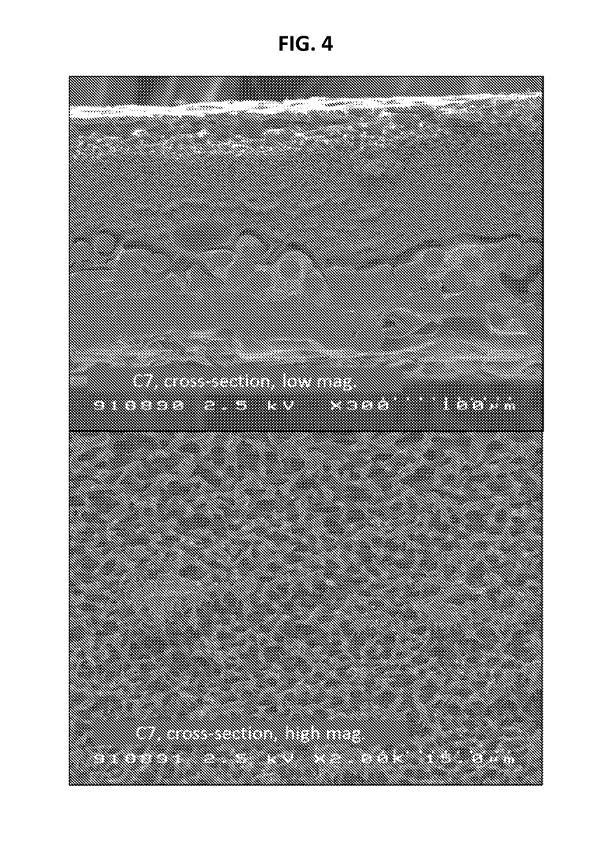

FIGS. 1 to 4 show scanning electron microscopy (SEM) images of comparative examples 1 (C1) and 7 (C7). They show the typical morphologies of these samples. The membrane surfaces are smooth (flat), similar to films, and show well defined pores penetrating into the thickness. The cross-section images show the membrane and the support layer. The structure of the pores through the thickness of the membrane is typical of membranes created by various processes known in the art, such as, for example, phase inversion processes, where a “foam” like structure of interconnected pores can be seen. Trans-membrane pores are not formed by the laying down of fibers in positions relative to each other that leave gaps for fluid to pass.

Nonwoven membranes (Samples 1-5) were prepared by an electroblowing process as described in U.S. Pat. No. 7,618,579, hereby incorporated in its entirety by reference. The as-spun nonwovens were then consolidated as described in US Patent Application Publication No. 2009/0261035, published Oct. 29, 2009.

The basic properties of Samples 1-5 are described in the table below.

TABLE 1
Sample properties

| | | Basis | | Mean Flow | Max. Flow |
|---|---|---|---|---|---|
| | | Weight | Thickness | Pore | Pore |
| Sample | Material | (g/m²) | (μm) | (μm) | (μm) |
| 1 | PES | 39 | 39 | 0.6 | 1.5 |
| 2 | PES | 39 | 40 | 0.8 | 1.8 |
| 3 | PES | 39 | 58 | 1.7 | 3.1 |
| 4 | PI | 14 | 35 | 1.7 | 2.6 |
| 5 | PI | 21 | 34 | 1.4 | 2.6 |

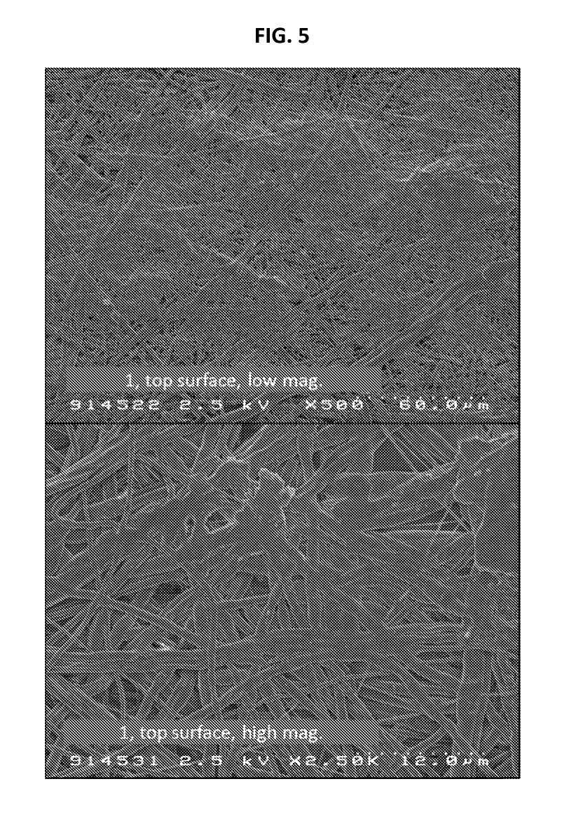

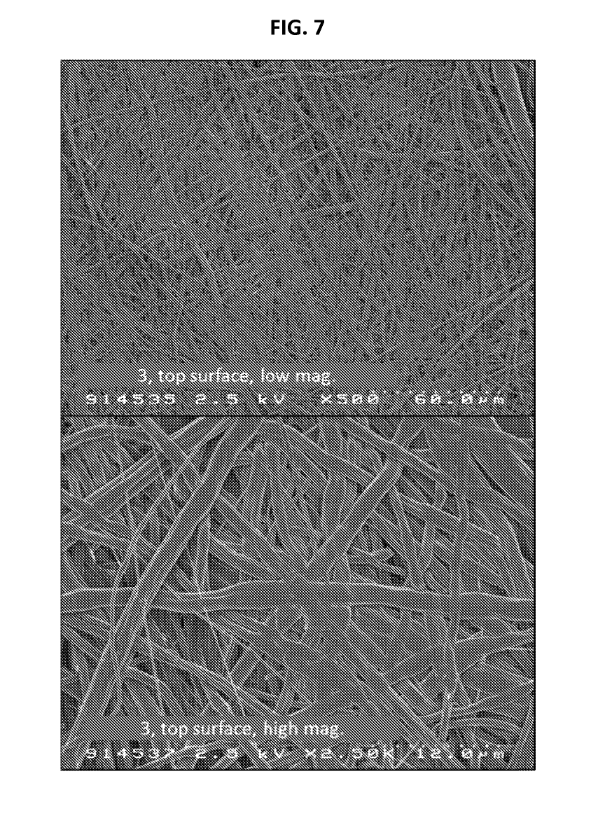

FIGS. 5 to 8 show SEM images of sample 1 and 3, which are representative of the structures of all of the samples. The top surface micrographs as shown on FIGS. 5 and 7 show the fibrous nature of the samples. Pores are formed by the laying down of fibers relative to each other. In these samples, the nanowebs shown have been calendared and partial consolidation of the surface has occurred. Areas where fibers have been fused into each other can be seen.

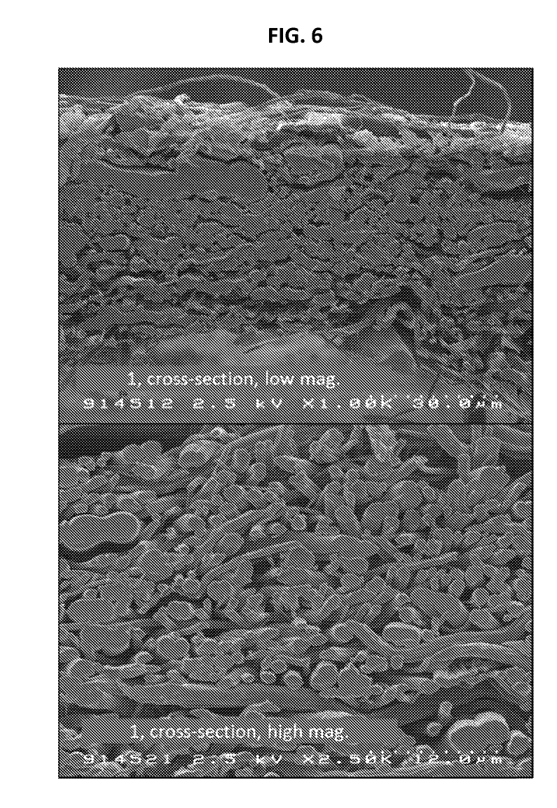

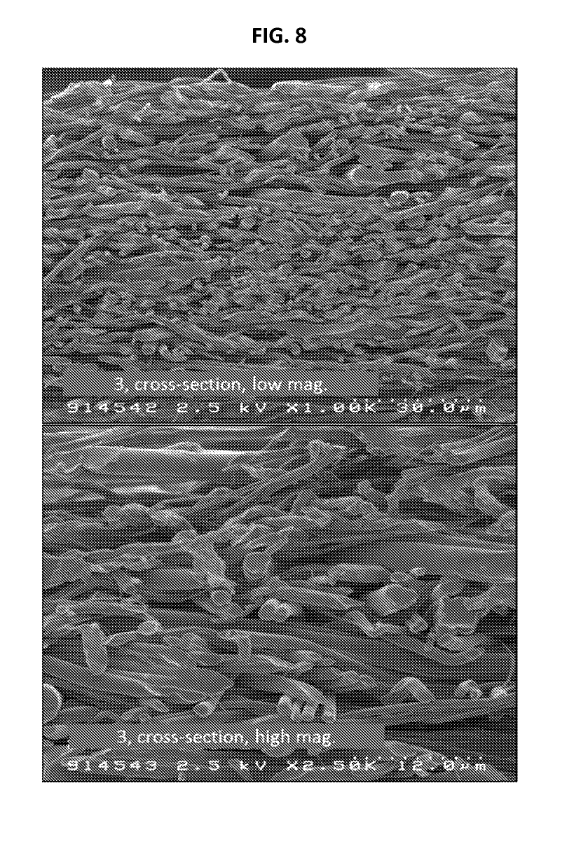

FIGS. 6 and 8 show cross sections of sample 1 and 3, respectively. The laying down of the fibers creates a complex network of pores traversing the thickness of the membrane. The pore size distribution is controlled through the spinning and consolidation processes. This is in contrast to the membranes of the comparative examples in which pores tend to extend from one surface to another with significantly less tortuosity.

A distinguishing feature of the presently claimed process is that the crossflow filtration membrane is a fibrous structure and not a film (e.g. cast, phase-inverted, fibrillated, or any other film known in the art). The pores are formed from the fiber laydown and not by holes, even by holes in any fibrillated structures that may exist in a film from which the membrane may have been formed.

### EXPERIMENTAL

### Membrane Installation and Preparation

A swatch of membrane (10 cm×14 cm) was cut-out by using a properly sized template. The membrane was installed into the (Sepa CF), using an 80 mil parallel spacer for the feed channel.

The membrane was then pre-treated before use in the process to remove residual glycerol and other chemicals from the membrane before use.

Pre-treatment for Koch membranes consisted of the steps of;
i. Flushing the system with water for 10 min at a crossflow rate of 3 liters/min and a pressure (at inlet) of 0.7 bar.
ii. Predissolving the cleaning chemicals (20 mL Ultrasil 110 and 1 g KX7011 from Ecolabs,) in 0.5 L of water on a stirring plate.
iii. After the water has circulated in the system for 0.5 h, checking the temperature in the feed tank. If it had reached 50° C.±5° C. adding the dissolved cleaning chemicals. If the temperature had not reached 50° C.±5° C. addition of cleaning chemicals was delayed until the temperature is reached and the additional time needed to reach temperature was noted.

After chemical addition feed was circulated for a further 0.5 hours. The steps listed above were repeated with the 20 mL Ultrasil 110, 1 g KX7011 and 8 mL Clorox® bleach. After 0.5 h cycle is done, the system was flushed until permeate (filtrate) and retentate (feed side) lines were neutral

Pre-treatment for all other membranes consisted of the steps of;
i. Flushing the system with water for 10 min at a Crossflow=3 L/min and a pressure (at inlet) of 0.7 bar.
ii. Filling the system with 3 L of water and setting the waterbath to 50° C.
iii. Circulating water for 15 minutes to reach 40° C.: Crossflow was 3 L/min, pressure (at inlet) was 0.7 bar
iv. Measuring the 10 mL Ultrasil 110.

After the water had circulated in the system for 15 minutes, the temperature in the feed tank was checked. If it had reached 40° C.±5° C. the cleaning chemicals were added. If the temperature has not reached 40° C.±5° C. cleaning chemicals were not added until the temperature was reached and the additional time required to come to temperature was noted.

After chemical addition, feed was allowed to continue to circulate for 15 minutes. After recirculating for 15 minutes, the system was flushed until permeate (filtrate) and retentate (feed side) lines were pH neutral.

### Filtration Testing

Clean water flux was measured according to the following equation.

$${CWF}_{25 ° C .} = \frac{{μ}_{t}}{{μ}_{25 ° C .}} * \frac{Q}{A * TMP}$$

where:

CWF_{25° C.} Clean water flux normalized to 25° C. (L/m²/hr/bar)
μₜ Viscosity of water at the test temperature (mPa*s)
μ_{25° C.} Viscosity of water at 25° C. (mPa*s)
Q Measured permeate rate (L/hr)
A Area of test membrane (m²)
TMP Trans-membrane pressure of test (bar)

Water was recirculated through the SepaCell and the permeation rate was measured at three different TMPs (0.9, 1.4, 1.9). The temperature was recorded, and then the CWF for each TMP set point was calculated from the above equation.

Filtration experiments were carried out in recirculation mode, both permeate and retentate returned to feed tank. 1.5 liters of fermentation broth and 1.5 liters of water were added to a jacketed feed vessel. The feed pump (Baldor-Electric 56C, 1.5 HP centrifugal pump) rate was set to 8 liters/min without exceeding 0.5 bar inlet pressure. Most experiments ran at between 6 and 7 liters/min, the inlet pressure being the most important parameter.

The feed was recirculated for 3 hours, maintaining the temperature set point required for the specific broth. Retentate and permeate were sampled every hour to determine the level of enzyme transmission through the membrane. Permeate flow rate, retentate recirculation rate, temperature and pressures were recorded every hour. The process flux is reported as the average flux recorded at 1, 2 and 3 hour of recirculation. The average enzyme transmission is reported as the average protein passage at 1, 2 and 3 hours of recirculation.

After 5 minutes, permeate samples were taken for breakthrough testing. Permeate was centrifuged at 14,000 rpm for 5 minutes in a microfuge. The centrifuged permeate was visually inspected for pellets. The supernatant turbidity was measured at OD 550 nm and reported as the difference in turbidity between the unspun permeate and the centrifuged permeate. Any results below 0.05 are considered equivalent due to the inherent variability in the measurement method.

For the first set of experiments (Experiment 1), the fermentation broth used for analysis was glucoamylase. Strain was Trichoderma reesei, consisting of whole cells in a defined medium with no insoluble. The process was run at 25° C.

The second set of experiments (Experiment 2) used a Trichoderma strain producing a multitude of hydrolytic enzymes, so a total protein assay was done to assess protein passage.

### Results

The following table (Table 2) summarize the experimental results obtained on the membranes of the invention and the comparative membranes.

TABLE 2
Summary of Results

| | | Average | | |
|---|---|---|---|---|
| | | Corrected | | |
| | | Clean Water | Average | Avg. |
| | | Flux (CWF) | Process | Protein |
| | | (LMH/bar) @ | Flux | Passage |
| Sample | Experiment | 25° C. | (LMH/bar) | (%) |
| 1 | 1 | 3240 | 2.12 | 66.0% |
| 2 | 1 | 5687 | 2.62 | 72.0% |
| 3 | 1 | 5568 | 2.70 | 60.0% |
| 4 | 1 | 5322 | 3.22 | 63.0% |
| 5 | 1 | 5387 | 2.20 | 70.0% |
| C1 | 1 | 115 | 1.70 | 37.7% |
| C2 | 1 | 496 | 4.04 | 2.0% |
| C3 | 1 | 354 | 3.36 | 22.7% |
| C4 | 1 | 492 | 2.63 | 24.9% |
| C5 | 1 | 250 | 1.32 | 17.5% |
| C6 | 1 | 614 | 3.74 | 43.3% |
| 4 | 2 | 5557 | 10.33 | 55.4% |
| C7 | 2 | 1840 | 1.89 | 67.7% |

These results show that under the conditions used in the laboratory test, the membranes of the inventions have significantly superior protein passage for equivalent process fluxes.

In addition, the clean water fluxes are approximately an order of magnitude superior to the comparative membranes. This result is significant as it allows a user in the field to lower the trans-membrane pressure (TMP) and still maintain a high permeate flux. Lowering the TMP is known in the art to result in a reduction in fouling of the membrane resulting in a longer run in between membrane cleaning cycles and an overall extended membrane life.

The filtration efficiency and membrane integrity was confirmed by analyzing the leakage through the membrane (Table 3). The turbidity difference values of the invention are on par with the comparative membrane C4 (which is representative of the others). Under the conditions of the test, the integrity of the invention is superior to that of the comparative sample as determined by the lack of pellets observed in the centrifuge.

TABLE 3
Leakage results

Leakage

| | | Delta- | |
|---|---|---|---|
| Sample | Experiment | turbidity | Pellets |
| 1 | 1 | 0.008 | no |
| 2 | 1 | 0.006 | no |
| 3 | 1 | 0.012 | no |
| 4 | 1 | 0.014 | no |
| 5 | 1 | 0.010 | no |
| C4 | 1 | 0.020 | yes |
| 4 | 2 | 0.010 | no |
| C7 | 2 | 0.002 | no |

The superior integrity of the invention permits the use without a supporting layer (scrim), therefore reducing the thickness of the separation element in a device. This allows for additional membrane to be included in a given device (defined volume) resulting is an increased total filtration capacity, or a reduction in the footprint of the process at a given capacity.

The present invention also provides a membrane for crossflow filtration which is capable of having high through-flow rates and is cost-effective.

What is claimed is:

1. A process for separating particles from a liquid stream comprising the steps of:
(a) providing a liquid stream to be filtered comprising particles and a membrane for separating the particles having a first surface, and a second surface that is opposite to the first surface;
(b) passing the liquid stream tangentially across the first surface of the membrane;
(c) recovering a particle rich fraction of the liquid stream from the first surface of the membrane; and
(d) recovering a particle depleted fraction of the liquid stream from the second surface of the membrane;
wherein the membrane comprises an active layer that has a fibrous structure in the form of a nonwoven, wherein the nonwoven has i) a mean flow pore size of 0.03 to 1.7 microns, ii) a maximum pore size of 3.1 microns or less, and iii) a mean thickness of the active layer of less than 300 microns.

2. The process of claim 1 wherein the fibrous structure comprises fibers that comprise one or more polymers.

3. The process of claim 2 wherein the one or more polymers are selected from at least one of polyethersulfone, polysulfone, polyimide, PVdF, polypropylene, polyamide, polyacrylonitrile, or cellulose or combinations thereof.

4. The process of claim 1 in which the active layer is unsupported.

5. The process of claim 1 in which the active layer comprises a plurality of distinct fibrous layers in a face to face relationship that are not mutually entangled.

6. The process of claim 1 in which the nonwoven is a nanoweb, and the nanoweb comprises nanofibers.

7. The process of claim 6 in which the nanofibers are continuous.

8. The process of claim 6 wherein the first surface of the membrane is a first surface of the nanoweb that is contacted with the liquid stream and the membrane further comprise a support layer that is attached to the nanoweb on a surface opposing the first surface of the nanoweb.

9. The process of claim 1 wherein the first surface of the membrane is a surface of the nonwoven that is contacted with the liquid stream.

10. The process of claim 9 wherein the surface of the nonwoven that is in contact with the liquid stream is at least partially fused.
